(19) United States
(12) Patent Application Publication
(10) Pub. No.: US 2007/0117502 A1
(43) Pub. Date: May 24, 2007

(54) Adjustable cooling air duct for use with components of different sizes

(75) Inventor: David S. Kim, Irvine, CA (US)

Correspondence Address: GATEWAY, INC.;ATTN: Patent Attorney, 610 GATEWAY DRIVE, MAIL DROP Y-04, N. SIOUX CITY, SD, 57049, US

(73) Assignee: Gateway Inc.

(21) Appl. No.: 11/284,664

(22) Filed: Nov. 22, 2005

(51) Int. Cl. B60H 1/00

(52) U.S. Cl. 454/139

(57) ABSTRACT

An adjustable duct system for guiding air flow is disclosed that includes an adjustable duct for guiding air flow. The adjustable duct comprises a perimeter wall that defines an air passage for the air flow, with the perimeter wall defining an entrance opening at the entry of the duct for receiving a flow of air and an exit opening at the exit of the duct for exhausting the flow of air. The perimeter wall includes a bottom wall portion, a top wall portion spaced from the bottom wall portion, and a pair of side wall portions extending between the top and bottom wall portions. The system also includes a movable flap for adjusting an effective area of the exit opening of the perimeter wall to adjust to different sizes of components to be cooled by the air flow.

### BACKGROUND OF THE INVENTION

1. Field of the Invention

The present invention relates to ducting for guiding cooling air flows, and more particularly pertains to a new cooling air duct that adjusts to different sizes of electronic components that are to be cooled by air moving through the duct.

2. Description of the Prior Art

Electronic devices such as computer information handling systems typically require some measure of cooling to remove heat from the various electronic components that comprise the electronic device. The electronic components generate heat, and the heat can build up in the interior of the case or housing of the electronic device if heat removal is not adequate. In many devices the heat removal, or cooling, is accomplished by causing or inducing an air flow through the interior of the device. Typically, this cooling air flow has been relatively random and unguided through the interior of the case between a fan in the power supply unit and vent openings in the case. However, as heat removal requirements of the information handling system have increased, the guidance of at least a portion of the air flow through the interior has become more desirable, so that those components that are more heat sensitive, or generate a disproportionate amount of heat, are subjected to a greater portion of the air flow.

One highly effective approach for influencing the path of the air flow through the interior of the case is by the use of ducts that guide at least a portion of the air flow entering the case. A number of ducts designs have been employed. To achieve the desired volume and direction of the cooling air flow, a duct needs to be relatively closely fitted to the elements generating the air flow (such as a fan) as well as the component receiving the enhanced degree of cooling. For example, in the case of processor chips that generate a significant amount of heat and must remain relatively cool to provide maximum performance, a heat sink is often mounted on the processor chip to draw the generated heat away from the chip. A duct intended to enhance the cooling of the processor chip is thus tailored to correspond to the particular size and shape of the heat ink so that air flowing out of the duct effectively flows over the heat sink.

In addition to the use of ducts is the fact that information handling systems, such as personal computers, for example, may be offered with a range of processor chips having different speeds and manufacturers, so that a range of different sizes and shapes of processing chips and heat sinks may be employed in the same model line of computers.

One drawback of the known duct designs is that the size of the ducts is relatively fixed, so different processors with different sizes require the use of different duct designs for different processor and heat sink combinations. The use of different duct designs not only complicates the process of assembling the computer, but also requires the maintenance of an inventory of a number of different duct designs for the same computer model.

Furthermore, some of the known duct designs rely upon various components, such as a circuit board, to form an element of the duct, so that attachment of the duct to the circuit board becomes critical to avoiding significant leakage of the air flow from the interior of the duct, which reduces the effectiveness of the duct. Further, some known ducts employ exterior structures such as handles that may damage other components of the computer during shipping, for example.

Thus, there exists a need for a cooling air duct that can accommodate a range of different sizes of processor chips or other components without a significant loss of effectiveness when used with the different sizes of components.

### SUMMARY OF THE INVENTION

The present invention provides a new air duct that is adjustable to adapt to a range of sizes of components, such as processors, so that one size of duct size may be employed on components throughout the range of sizes and the need for ducts of different sizes for the different sized ducts is avoided.

In one aspect of the invention, an adjustable duct system is disclosed, and includes an adjustable duct for guiding air flow. The adjustable duct comprises a perimeter wall defining an air passage for the air flow, and the perimeter wall defines an entrance opening at the entry of the duct for receiving a flow of air and an exit opening at the exit of the duct for exhausting the flow of air. The perimeter wall includes a bottom wall portion, a top wall portion spaced from the bottom wall portion, and a pair of side wall portions extending between the top and bottom wall portions. The adjustable duct system further includes adjusting means for adjusting an effective area of the exit opening of the perimeter wall.

In another aspect of the invention, an information handling system is disclosed that includes a housing which defines an interior, and has at least one opening for permitting air to flow through into the interior of the housing. The system further comprises an electronic component located in the interior of the housing, and a fan for creating a flow of cooling air in the interior of the housing for cooling the electronic component. The system further comprises an adjustable duct for guiding air flow from the opening to the electronic component, and includes a perimeter wall defining an air passage for the air flow. The perimeter wall defines an entrance opening at the entry of the duct for receiving a flow of air and an exit opening at the exit of the duct for exhausting the flow of air. The perimeter wall includes a bottom wall portion, a top wall portion spaced from the bottom wall portion, and a pair of side wall portions extending between the top and bottom wall portions. The adjustable duct further includes adjusting means for adjusting an effective area of the exit opening of the perimeter wall.

This is a general outline of the more significant features of the invention, and the detailed description of this application that follows discloses additional features of the invention which will form the subject matter of the claims appended hereto.

One significant benefit of the present invention is the ability to adjust the effective area of the exit of the duct to a variety of sizes of components and any associated heat sink, so that a variety of different sizes of air ducts do not have to be inventoried for user with components of different sizes.

Further advantages of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a schematic front perspective view of a new adjustable duct of the present invention.

FIG. 2 is a schematic rear perspective view of the present invention.

FIG. 3 is a schematic front view of the present invention.

FIG. 4 is a schematic rear view of the present invention. FIG. 5 is a schematic side sectional view of the present invention.

### DESCRIPTION OF PREFERRED EMBODIMENTS

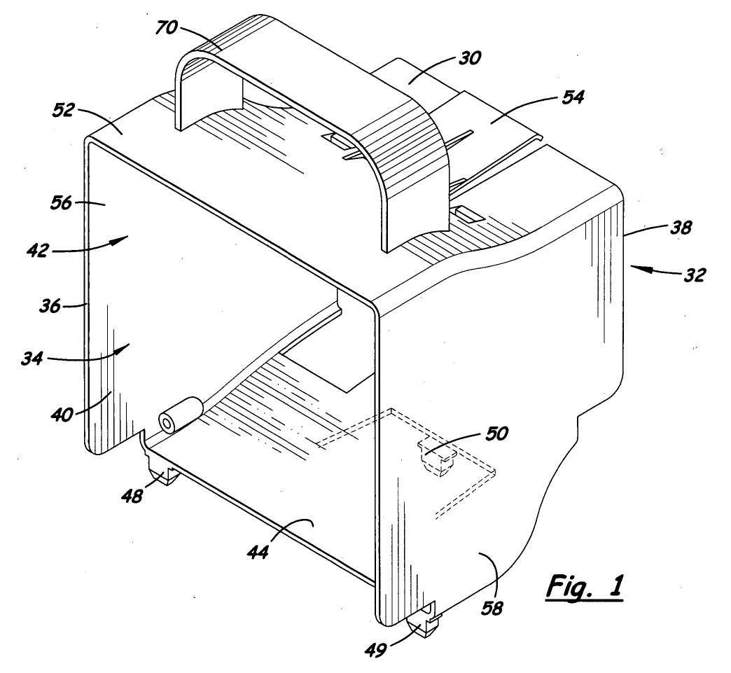

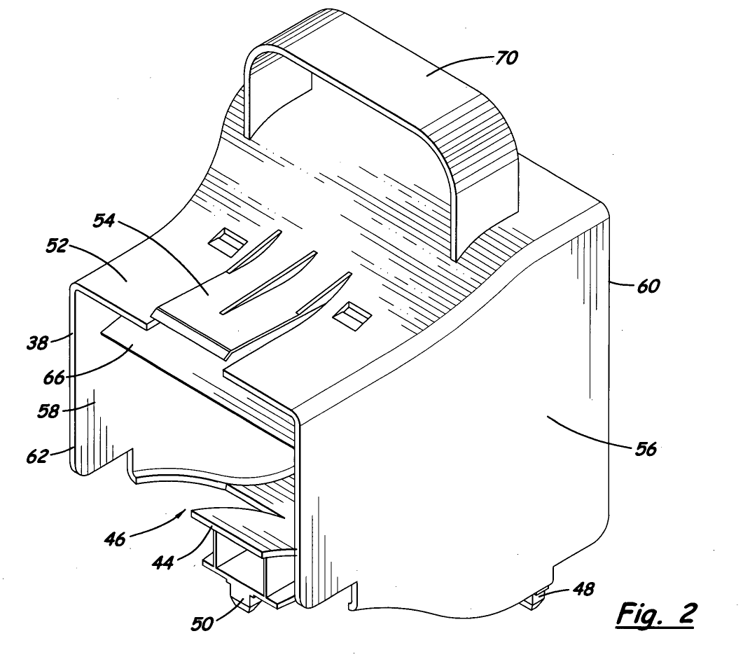

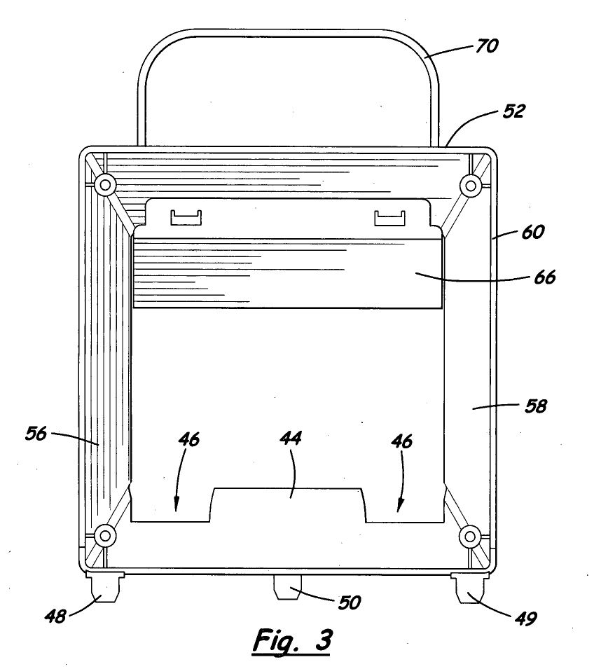

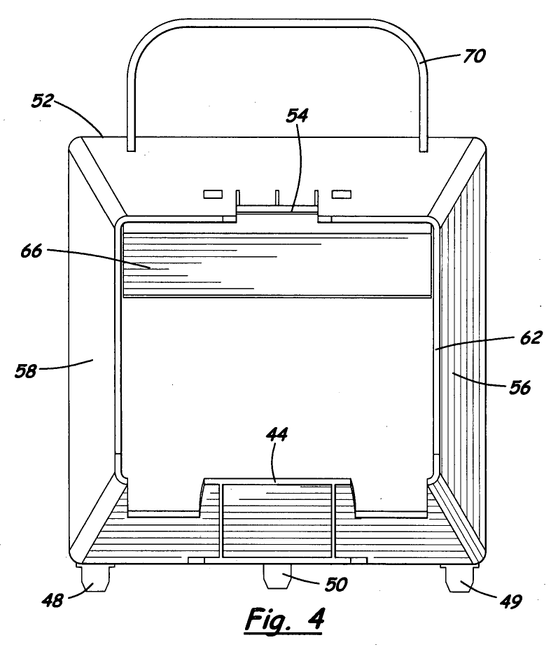

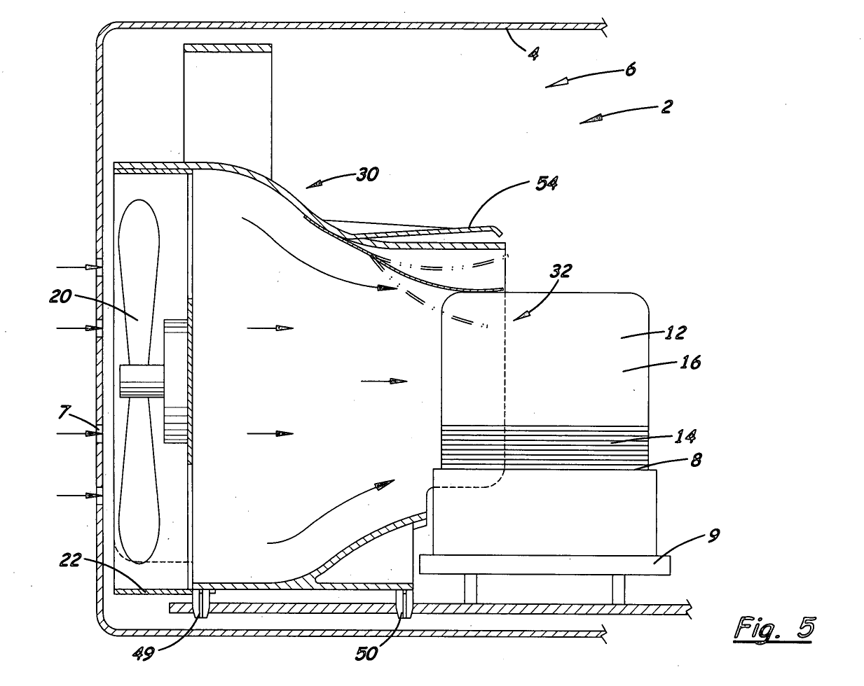

With reference now to the drawings, and in particular to FIGS. 1 through 5 thereof, a new adjustable air duct embodying the principles and concepts of the present invention and generally designated by the reference numeral 10 will be described.

The adjustable air duct 10 of the invention is highly suitable for use on an electronic device, such as an information handling system 2 implemented as a personal computer, although it should be recognized in view of this disclosure that the adjustable air duct may be implemented on a number of different electronic devices.

An illustrative information handling system 2 (see FIG. 5) includes a housing 4 or case that defines an interior 6 of the system. The housing 4 may have at least one opening 7 in a wall of the housing for permitting air to flow through into the interior of the housing. The information handling system 2 includes an electronic component 8 located in the interior of the housing 4. The electronic component 8 may comprise a central processing unit integrated circuit chip, but may also comprise a processing chip devoted to other functions. Optionally, the invention may be suitable for use with other electronic components of the information handling system, but the invention finds a particularly beneficial application with processor chips, as the size and configuration of the processor chip employed on an information handling system 2 may be relatively easily varied within the same model line without significantly altering the physical configuration of most of the other components of the information handling system. The type and size of a processor chip installed on a particular model of information handling system may be varied during the production life of the model to provide a number of performance and price points in the model line, as well as due to periodic upgrading of the specifications of the model line.

In many information handling systems, and particularly in the illustrative embodiment of the invention described herein, a heat sink 12 is employed to remove heat generated by the electronic component from the component, typically by dissipating the heat to the air in the interior 6 of the housing 4, which in most systems is aided by the movement of the air through the interior of the housing. The heat sink 12 is mounted in a manner suitable to facilitate thermal communication between the electronic component and the heat sink as known to skilled in the art, so that heat generated by the electronic component is readily transferred to the heat sink. In the application in which the electronic component is a processing chip, the heat sink 12 is mounted on the topside or backside of the chip opposite of the position of the circuit board on which the chip is mounted, so that the chip is located between the board and the heat sink, although it will be appreciated that other orientations are possible. Commonly, the heat sink 12 comprises a thermally conductive material, such as a metal (for example, aluminum), or other material with relatively high thermal conductivity. In many configurations, the heat sink 12 includes a base 14 that is mounted on the electronic component 8 and a plurality of fins 16 that extend outwardly from the base, and typically upwardly with respect to the component.

The total height of the heat sink 12 and the electronic component from which the heat sink is dissipating heat will often vary depending upon the size of the component itself and the size of the heat sink. Physically larger components will often generate relatively more heat than smaller components, and will thus require physically larger heat sinks to dissipate that heat. In the case of processing chips, the footprint of the chip on the circuit board may remain the same or similar between processors of different speeds or processing capabilities, and thus may be used on the same circuit boards and mounting sockets, but the heat generated by the faster speeds may increase the heat dissipation needs significantly, and thus even chips with the same physical sizes may employ heat sinks of significantly different exterior dimensions.

The system 2 may also include a fan 20 (see FIG. 5) for creating a flow of air in the interior 6 of the housing for cooling the electronic component 8. In the illustrative embodiment of the invention, the fan 20 is located in the interior 6 of the housing, and is located adjacent to the opening 7 in the housing for inducing the air flow through the opening and into the interior of the housing, such as is employed on computers that utilize the Balanced Technology Extended (BTX) form factor. Optionally, the fan 20 may be a part of a power supply of the system 10. The fan 20 may be located in a shroud 22 that surrounds the circumference of the fan.

A significant feature of the invention is an adjustable duct 30 (see FIGS. 1 through 4) for guiding the air flow of the fan 20 to the electronic component 8 (and a heat sink 12 if one is associated with the electronic component) positioned adjacent to an exit 32 of the duct. The adjustable duct 30 receives the flow of cooling air from the fan 20 positioned at an entry 34 of the duct 30. The adjustable duct 30 has a longitudinal direction that extends from the entry 43 of the duct to the exit 32 of the duct.

The adjustable duct 30 may comprise a perimeter wall 40 that defines an air passage 42 for guiding the flow of air. The perimeter wall 40 defines an entrance opening 36 at the entry 34 of the duct 30 for receiving a flow of air and an exit opening 38 at the exit 32 of the duct for exhausting the flow of air. The perimeter wall 40 may form a substantially continuous perimeter about the air passage 42 in a plane transverse to the longitudinal direction of the duct.

In greater detail, the perimeter wall 40 includes a bottom wall portion 44, which may be positioned adjacent to a circuit board 9 on which the electronic component 8 is mounted. The bottom wall portion 44 may substantially separate the air flow from the circuit board 9, and may diverge from the circuit board as the bottom wall portion extends from the entry 34 to the exit 32 of the duct 30. In one preferred embodiment of the invention, the bottom wall portion 44 includes one or more notches or cut out portions to facilitate a secondary air flow past a side of the circuit board 9 opposite of the side on which the electronic component 8 is located. Illustratively, a pair of the notches 46 are laterally spaced with respect to a longitudinal centerline of the bottom wall portion, with a relatively central section of the bottom wall portion being positioned between the notches.

A foot structure may be included on the duct 30 that extends from the bottom wall portion 44 downwardly for engaging a portion of the chassis of the housing 4, or even the circuit board 9. The foot structure may include a plurality of feet, and in the illustrative embodiment, a pair 48, 49 of the feet are located toward the entry 34 of the duct 10, and another foot 50 is located toward the exit 32 of the duct, although it will be appreciated that other arrangements of the feet may be employed. Each of the feet may have a width that tapers toward the end of the foot, to facilitate insertion of the foot into a respective hole on the chassis of the housing 4 or the circuit board.

The perimeter wall 40 of the duct 30 may also include a top wall portion 52 that is spaced from the bottom wall portion 44. The top 52 and bottom 44 wall portions may converge toward each other toward the exit opening 38 and diverge away from each other toward the entrance opening 36. In one embodiment of the duct, the top wall portion 52 extends a greater distance from the entrance opening 36 than the bottom wall portion 44 extends from the entrance opening such that the bottom wall portion has a relatively shorter longitudinal length than the top wall portion. Optionally, the top wall portion 52 may include a tongue section 54 that functions to removably receive and secure cabling (such as a ribbon cable) in the interior of the housing. The tongue section 54 is partially separated from the remainder section of the top wall portion, and may extend from a centralized area of the top wall portion 52 toward the exit opening 38, and may also terminate at the exit opening 38.

The perimeter wall 40 may also include a pair of side wall portions 56, 58 that each extend between the top 52 and bottom 44 wall portions and are laterally spaced from each other with respect to the longitudinal axis of the duct. The pair of side wall portions 56, 58 may converge toward each other toward the exit opening 38, and conversely diverge away from each other toward the entrance opening 36. The convergence of the top, bottom and side wall portions toward the exit opening causes the area of the entrance opening to be greater in size than the area of the exit opening to create a stronger, more focused air flow at the exit of the duct and onto the component located at the exit.

The entrance opening 36 of the duct 10 may be defined by an entrance edge 60, and in one embodiment the entrance edge lies substantially in a plane with the exception of a lower section of the entrance edge. In some embodiments of the invention, the fan 20 is at least partially located in the entrance portion of the duct 10 to increase the degree of air tightness between the duct and the shroud 22 of the fan. The exit opening 38 may be defined by an exit edge 62. In one embodiment, the section of the exit edge that extends along on the top wall portion 52 and upper sections of the side wall portions 56, 58 may lie in a plane, and the section of the exit edge that extends along the bottom wall portion 44 and lower sections of the side wall portions also lie substantially in a plane, and the plane of the lower section of the exit edge is relatively close to the entrance opening 36 than the plane of the upper section of the exit edge, a feature which allows an upper portion of the duct to extend over the component 8 and any associated heat sink.

Significantly, the duct 10 includes means for adjusting an effective area of the exit opening 38 of the perimeter wall, so that the air flow exiting the duct is concentrated on the component and any associated heat sink whether the component and heat sink are relatively tall or relatively short with respect to the exit opening. In the illustrative embodiment of the invention, the adjusting means comprises a movable flap 66 that is at least partially adjustably positionable with respect to the perimeter wall. The movable flap 66 is positioned in the air passage 42 of the perimeter wall 40, is movable to decrease the effective area of the exit opening 38. The movable flap 66 may be mounted on the perimeter wall 40 between the entrance opening 36 and the exit opening 38, and extend toward the exit opening. In one embodiment, the movable flap 66 is mounted on the top wall portion 52 of the perimeter wall, and extends generally along a section of the top wall portion of the perimeter wall located toward the exit opening 38, but it is conceivable that the flap may be mounted on another of the wall portions of the duct. The movable flap 66 may be flexible to permit flexing of at least a section of the movable wall away from the top wall portion 52. The movable flap 66 is preferably formed of a suitably flexible material that has some degree of resiliency and rigidity, such as a suitable plastic material. The movable flap 66 may be formed so that the portion of the flap nearest the exit opening 38 is biased toward the bottom wall portion 44 so that the flap may maintain a position against the component and any associated heat sink. The flap 66 may also include preformed ridges and grooves at longitudinally-spaced locations on the flap to facilitate bending the flap across its length.

Another significant aspect of the invention is a handle 70 that is mounted on the perimeter wall 40 of the duct 10. The handle 70 is preferably located on the top wall portion 52 of the perimeter wall and extends away from the perimeter wall. The handle 70 may abut against a portion of the housing located substantially opposite of the circuit board in the interior 6 of the housing to form a spacer that holds the duct 10 in place in the housing. In the illustrative embodiment, the handle 66 forms a loop, with opposite ends of the handle being connected to the perimeter wall and extending away from the perimeter wall.

As an option, the movable flap 66 may be made relatively easily removable from the perimeter wall 40, so that the flap may be removed during assembly for applications where the size of the component and any associated heat sink substantially corresponds to the size of the exit opening, and may be left in place for those applications where the size of the component and any associated heat sink is less than the size of the exit opening.

The foregoing is considered as illustrative only of the principles of the invention. Further, since numerous modifications and changes will readily occur to those skilled in the art in view of the disclosure of this application, it is not desired to limit the invention to the exact embodiments, implementations, and operations shown and described. Accordingly, all equivalent relationships to those illustrated in the drawings and described in the specification, including all suitable modifications, are intended to be encompassed by the present invention that fall within the scope of the invention.

1. An adjustable duct system for guiding air flow, the system comprising:
an adjustable duct for guiding air flow, the adjustable duct comprising:
a perimeter wall defining an air passage for the air flow, the perimeter wall defining an entrance opening at the entry of the duct for receiving a flow of air and an exit opening at the exit of the duct for exhausting the flow of air, the perimeter wall including a top wall portion, and a pair of side wall portions extending from the top wall portion; and
adjusting means for adjusting an effective area of the exit opening of the perimeter wall.

2. The system of claim 1 wherein the adjusting means comprises a movable flap adjustably positionable with respect to the perimeter wall, the movable flap being movable to decrease the effective area of the exit opening of the perimeter wall.

3. The system of claim 2 wherein the movable flap is positioned in the air passage of the perimeter wall.

4. The system of claim 2 wherein the movable flap is mounted on the perimeter wall between the entrance opening and the exit opening and extending toward the exit opening.

5. The system of claim 2 wherein the movable flap is mounted on the top wall portion of the perimeter wall, the movable flap extending generally along a section of the top wall portion of the perimeter wall toward the exit opening.

6. The system of claim 2 wherein the movable flap is flexible to permit flexing of a section of the movable wall away from the top wall portion

7. The system of claim 1 additionally comprising a handle mounted on the perimeter wall.

8. The system of claim 1 additionally comprising a foot structure extending downwardly from the bottom wall portion toward the exit of the duct to orient the duct with respect to the circuit board.

9. The system of claim 1 additionally comprising a bottom wall portion spaced from the top wall portion and extending between the side wall portions, wherein the top and bottom wall portions converge toward each other toward the exit opening, and the pair of side wall portions converging toward each other toward the exit opening such that an area of the entrance opening is greater in size than the area of the exit opening.

10. The system of claim 1 wherein the top wall portion includes a tongue section capable of engaging a cable to hold the cable on the perimeter wall.

11. The system of claim 1 additionally comprising a bottom wall portion spaced from the top wall portion and extending between the side wall portions, wherein the top wall portion extends a greater distance from the entrance opening than the bottom wall portion extends from the entrance opening.

12. An information handling system comprising:
a housing defining an interior, the housing having at least one opening for permitting air to flow through into the interior of the housing;
an electronic component located in the interior of the housing;
a fan for creating a flow of cooling air in the interior of the housing for cooling the electronic component; and
an adjustable duct for guiding air flow from the opening to the electronic component, the adjustable duct comprising:
a perimeter wall defining an air passage for the air flow, the perimeter wall defining an entrance opening at the entry of the duct for receiving a flow of air and an exit opening at the exit of the duct for exhausting the flow of air, the perimeter wall including a bottom wall portion, a top wall portion spaced from the bottom wall portion, and a pair of side wall portions extending between the top and bottom wall portions; and
an adjusting structure configured to adjust an effective area of the exit opening of the perimeter wall.

13. The system of claim 1 wherein the adjusting structure comprises a movable flap adjustably positionable with respect to the perimeter wall, the movable flap being movable to decrease the effective area of the exit opening of the perimeter wall.

14. The system of claim 12 additionally comprising a heat sink in thermal communication with the electronic component, the heat sink being positioned adjacent to the exit opening of the perimeter wall.

15. The system of claim 13 wherein the movable flap is positioned in the air passage of the perimeter wall.

16. The system of claim 13 wherein the movable flap is mounted on the perimeter wall between the entrance opening and the exit opening and extending toward the exit opening.

17. The system of claim 13 wherein the movable flap is mounted on the top wall portion of the perimeter wall, the movable flap extending generally along a section of the top wall portion of the perimeter wall toward the exit opening.

18. The system of claim 13 wherein the movable flap is flexible to permit flexing of a section of the movable wall away from the top wall portion

19. The system of claim 12 additionally comprising a handle mounted on the perimeter wall.

20. The system of claim 12 wherein the top and bottom wall portions converge toward each other toward the exit opening, and the pair of side wall portions converging toward each other toward the exit opening such that an area of the entrance opening is greater in size than the area of the exit opening.

21. An adjustable duct system for guiding air flow, the system comprising:
an adjustable duct for guiding air flow, the adjustable duct comprising:
a perimeter wall defining an air passage for the air flow, the perimeter wall defining an entrance opening at the entry of the duct for receiving a flow of air and an exit opening at the exit of the duct for exhausting the flow of air, the perimeter wall including a top wall portion and a pair of side wall portions extending between the top and bottom wall portions; and
an adjusting structure configured to adjust an effective area of the exit opening of the perimeter wall.

22. The system of claim 21 wherein the adjusting structure comprises a movable flap adjustably positionable with respect to the perimeter wall, the movable flap being movable to decrease the effective area of the exit opening of the perimeter wall.

23. The system of claim 22 wherein the movable flap is positioned in the air passage of the perimeter wall.

24. The system of claim 22 wherein the movable flap is mounted on the perimeter wall between the entrance opening and the exit opening and extending toward the exit opening.

25. The system of claim 22 wherein the movable flap is flexible to permit flexing of a section of the movable wall away from the top wall portion

26. The system of claim 21 wherein the top wall portion includes a tongue section capable of engaging a cable to hold the cable on the perimeter wall.

27. The system of claim 1 wherein the perimeter wall includes a bottom wall portion spaced from the top wall portion and extending between the side wall portions.
